(19) United States
(12) Patent Application Publication
(10) Pub. No.: US 2011/0011082 A1
(43) Pub. Date: Jan. 20, 2011

(54) Emissions Control System Having External Turbocharger Wastegate and Integrated Oxidation Catalyst

(75) Inventors: Darius Mehta, San Antonio, TX (US); Terrence F. Alger, II, San Antonio, TX (US); Chad P. Koci, San Antonio, TX (US)

Correspondence Address: CHOWDHURY & GEORGAKIS, P.C, P.O. Box 17299, Sugar Land, TX, 77496, US

(73) Assignee: Southwest Research Institute, San Antonio, TX (US)

(21) Appl. No.: 12/502,645

(22) Filed: Jul. 14, 2009

(51) Int. Cl. F02D 23/00; F01N 3/10; F02G 3/00

(52) U.S. Cl. 60/602; 60/299; 60/614

(57) ABSTRACT

A method and system for reducing undesired exhaust emissions during cold start of a turbocharger-equipped internal combustion engine. A bypass line in the engine compartment has a bypass valve that permits exhaust to be bypassed around the turbocharger's turbine during cold start. An oxidation catalyst is closely coupled to the bypass valve.

### TECHNICAL FIELD OF THE INVENTION

This invention relates to internal combustion engine systems for vehicles, and more particularly to such engine systems having turbochargers.

### BACKGROUND OF THE INVENTION

As concern over energy independence increases, automotive manufacturers are resorting to more complicated measures to increase the fuel efficiency of their products. One common way to do this is to decrease the engine size and add a turbocharger. At low loads, this configuration results in higher efficiency because the smaller engine means that the throttle must be open more for the power required to move the vehicle, which significantly reduces pumping losses. In addition, at high loads, the relatively high specific power of a small engine means that incremental losses due to friction are much lower.

However, to achieve the high levels of specific power required to make this strategy effective, turbochargers must be used to increase the mass flow through the engine. However, turbocharging equipment presents obstacles to low emissions operation, particularly during cold start testing.

Typical exhaust emissions standards usually include some form of cold start testing, requiring the engine to bring the emissions aftertreatment system up to temperature quickly. For aftertreatment systems that rely on catalytic reactions, this results in a “light off” period. During a normal cold start, the aftertreatment system is at ambient temperature and energy from the engine exhaust must warm the hardware to a temperature at which catalyst reactions can occur. This light off period can range from 12-20 seconds in a gasoline application to over a minute in a lean-burn or diesel application. Shortening the light off period is a challenge of emissions treatment, since most results show that up to 40% of all emissions from a vehicle are generated during this period when the catalysts are not active.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a turbocharged engine system having an external wastegate valve and oxidation catalyst in accordance with the invention.

FIG. 2 illustrates a second embodiment of the turbocharged engine system of FIG. 1, and also having an additional restriction valve.

### DETAILED DESCRIPTION OF THE INVENTION

As indicated in the Background, it is expected that smaller, boosted engines will have considerable difficulty meeting U.S. emissions standards. A feature of the invention is the recognition that a significant factor in prolonged catalyst light-off periods is that the mass of the exhaust system between the catalyst and the engine must be warmed up by the exhaust gases, reducing the amount of energy available to increase the catalyst temperature.

The presence of a turbocharger makes this warming even more difficult. The thermal mass of the turbocharger's turbine (vanes, housing, etc.) leads to significant heat losses from the exhaust gas to the turbine. At the low load conditions of the cold start, the expansion across the turbine is much less important in terms of losing energy than simply the thermal mass of the assembly. The invention described herein is directed to a solution to the difficulty of achieving a quick cold-start catalyst light-off with a turbocharged engine.

Turbochargers are typically equipped with a wastegate, which allows the turbine to be bypassed when exhaust flow rates are too high. Without a wastegate, the amount of boost from the turbocharger's compressor increases with the pressure of the engine's exhaust. Because exhaust pressure increases with engine speed (RPM's), as an engine reaches higher RPM's, the turbocharger generates increasing amounts of boost. The problem with this is that an engine can only accommodate a given amount of boost.

A wastegate is a valve that diverts exhaust gases away from the turbine in a turbocharged engine system. Diversion of exhaust gases regulates the turbine speed, which in turn regulates the rotating speed of the compressor. Thus, the function of the wastegate is to regulate the maximum boost pressure in turbocharger systems, to protect the engine and the turbocharger.

There are two types of wastegates. An internal wastegate is an integral part of the turbocharger. From an internal wastegate, excess exhaust is fed directly into the exhaust system. An external wastegate, unlike an internal wastegate, is separate from the turbocharger. Excess exhaust can either be fed into the exhaust system or it can be vented directly into the atmosphere.

Most production vehicles are equipped with an internal wastegate, as this configuration is better suited for low boost applications (approximately 10 PSI) and for operation in everyday traffic conditions. However, for high performance vehicles an external wastegate is sometimes used for the purpose of generating boost in the range of 20-30 PSI.

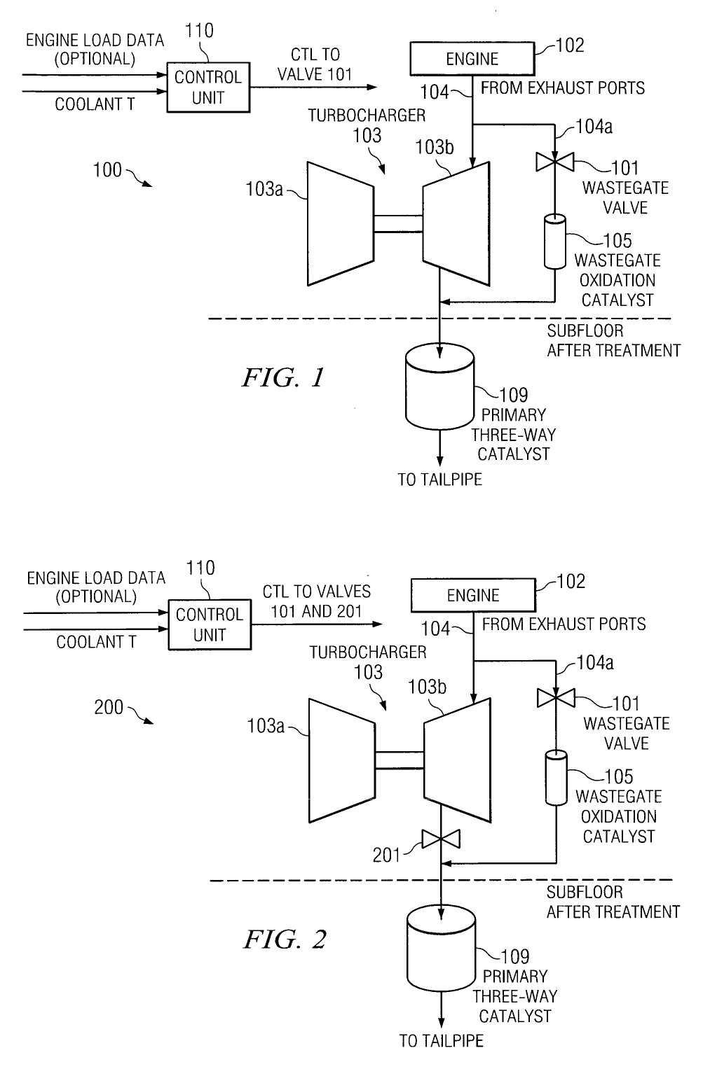

FIG. 1 illustrates an engine system 100 having a turbocharger 103 and external wastegate valve 101 in accordance with the invention. Wastegate valve 101 is essentially an external turbine bypass valve. It follows that the turbocharger's turbine 103b has no internal wastegate, that function being performed by external valve 101.

The main exhaust line 104 has a first portion that carries exhaust from the engine to the turbine 103b. A second portion of the main exhaust line 104 carries exhaust from the turbine, then under the floor of the vehicle to a three-way catalyst 109. Catalyst 109 may be a conventional catalyst of the type used for treating automotive exhaust. From catalyst 109, the exhaust is emitted into the atmosphere via a tailpipe.

The wastegate valve 101 is placed on a bypass line 104a, which bypasses the turbocharger's turbine 103b. The bypass line 104 diverts from the main exhaust line between engine 102 and the input to the turbine 103b, and rejoins the main exhaust line downstream turbine 103b and upstream the three-way catalyst 109. The re-entry of bypass line 104a to the post-turbine portion of the main exhaust line is within the engine compartment.

Downstream the wastegate valve 101, also on the bypass line 104, a small oxidation catalyst 105 reduces the hydrocarbon and carbon monoxide from the engine 102 during cold start. The oxidation catalyst 105, being close to the engine 102, and more readily heated, will become active faster. In addition, the catalyst 105 will generate an exotherm by oxidizing the hydrocarbons and carbon monoxide in the exhaust gases, resulting in higher temperature gases flowing to the primary, underfloor catalyst 109. This will decrease the light-off time for the primary catalyst 109, reducing the total emissions from the vehicle.

As indicated in FIG. 1, the bypass line 104a, wastegate valve 101, and oxidation catalyst 105 are all closely coupled to the engine 102 and are located in the engine compartment. In contrast, the primary catalyst 109 is a sub-floor device, and emits exhaust to the atmosphere via the tailpipe.

The wastegate valve 101 and oxidation catalyst 105 are “integrated” in the sense that they are very closely coupled to each other. In the embodiment of FIG. 1, exhaust from the wastegate valve 101 directly and immediately enters the oxidation catalyst 105. In other embodiments, catalyst 105 could be placed immediately upstream valve 101. A common feature of both embodiments is that catalyst 105 is on the bypass line 104a, so that if any deterioration of the catalyst will not adversely affect the turbine.

Control unit 110 may be processor-based, programmed to control valve 101 as described herein. In general, control unit 110 may be implemented with various controller devices known or to be developed. Further, control unit 110 may be part of a more comprehensive engine control unit that controls various other engine and/or emissions devices.

In operation, during cold start, wastegate valve 101 is open so that exhaust passes from engine 102 into bypass line 104a, bypassing turbine 103b. System 100 has appropriate sensors for measuring temperature, so that a cold start condition can be determined. Typically, the temperature used for determining a cold start vehicle condition is coolant temperature.

Engine load may also be a factor in determining the open or closed state of valve 101. Where turbocharger 013 is a variable geometry turbocharger, valve 101 would be used for cold start mode and the turbocharger could be used to regulate boost in the conventional manner. Control unit 110 would be appropriately programmed to control the variable geometry turbocharger.

However, for turbochargers that do not have variable output, which would otherwise use a wastegate for boost control in the conventional manner, valve 101 may be used for boost control as well as for cold starting. In this case, valve 101 could be implemented as a variable aperture valve so that the amount of exhaust through bypass line 104a could be controlled. As stated above, controller 110 is appropriately programmed to receive input data and to deliver control signals to valve 101 during cold start, and if appropriate, for boost control.

In sum, the external wastegate valve 101 closely coupled with an oxidation catalyst 105 can significantly reduce the hydrocarbon and carbon monoxide emissions from a turbocharged engine. The catalyst 105 will light-off quickly and is less affected by the thermal mass of the turbocharger boosting system. This system reduces light off time of the primary catalyst 109 by providing a source of heat due to the oxidation of exhaust emissions. The external wastegate valve 101 further reduces the light-off time by bypassing some or all of the exhaust around the high thermal mass of the turbocharger 103. By bypassing exhaust gas around the turbine 103b, the external wastegate valve 101 reduces the heat losses that occur in the exhaust system.

FIG. 2 illustrates a modified embodiment, showing an engine system 200 having an additional restriction valve 201 placed on the main exhaust line 104. In the embodiment of FIG. 2, the valve is located downstream the turbocharger's turbine and upstream of the point where bypass line 104a rejoins the main exhaust line 104. Valve 201 is closed during cold start conditions to ensure more exhaust flow forced through the bypass line 104a. For cold starting, control of valve 201 is achieved by control unit 110 under the same cold start conditions as valve 101. If turbocharger 103 is a variable geometry turbocharger, the same effect may be achieved by closing the vanes of the turbocharger during cold starting.

What is claimed is:

1. A method of reducing undesired exhaust emissions from an internal combustion engine of a vehicle also having a turbocharger, comprising:
determining whether the vehicle is in a cold start mode;
if the vehicle is in cold start mode, delivering exhaust from the engine to a bypass line around the turbine of the turbocharger;
wherein the delivering step is performed by opening a valve on the bypass line;
wherein the bypass line diverts from the main exhaust line upstream the turbine and rejoins the main exhaust line within the engine compartment;
passing the exhaust through an oxidation catalyst on the bypass line;
directing the exhaust from the bypass line into the main exhaust line; and
treating the exhaust with an under-floor exhaust aftertreatment system on the main exhaust line; and
exhausting the exhaust into the atmosphere via a tailpipe.

2. The method of claim 1, determining step is performed by measuring temperature at a point in the engine compartment.

3. The method of claim 1, wherein the temperature is coolant temperature.

4. The method of claim 1, further comprising the step of determining engine load when the engine is not in cold start mode, and further comprising the step of using the valve to bypass all or some of the exhaust through the bypass line.

5. The method of claim 1, wherein the bypass valve is a variable opening bypass valve.

6. The method of claim 1, wherein the turbocharger is a variable geometry turbocharger.

7. The method of claim 1, further comprising the step of using a valve on the main exhaust line to close the exhaust flow through the main exhaust line during cold start conditions.

8. An exhaust emissions system for reducing undesired exhaust emissions from an internal combustion engine of a vehicle also having a turbocharger, comprising:
a first exhaust line from the engine to the turbine of the turbocharger;
a second exhaust line from the turbine to a three way catalyst, the second exhaust line beginning in the engine compartment and passing through the floor of the vehicle;
at least one underfloor aftertreatment device for treating exhaust emissions and exiting treated exhaust to the atmosphere via a tailpipe;
a bypass line for diverting exhaust around the turbine, the bypass line have a diversion point between the engine and the turbine and having a re-entry point in the engine compartment to the second exhaust line;
a wastegate valve on the bypass line; and
an oxidation catalyst on the bypass line downstream the wastegate valve.

9. The system of claim 8, wherein the bypass valve is a variable opening bypass valve.

10. The system of claim 8, wherein the turbocharger is a variable geometry turbocharger.

11. The system of claim 8, wherein the aftertreatment device is a three-way catalyst.

12. The system of claim 8, further comprising a control unit programmed to open the bypass valve during cold start engine conditions.

13. The system of claim 12, wherein the control unit is further programmed to control the bypass valve to limit boost from the turbocharger.
